(19) United States
(12) Patent Application Publication
(10) Pub. No.: US 2025/0189792 A1
(43) Pub. Date: Jun. 12, 2025

(54) OPTICAL MEMBER, DISPLAY DEVICE, AND MANUFACTURING METHOD

(71) Applicant: Panasonic Automotive Systems Co., Ltd., Kanagawa (JP)

(72) Inventor: Toshiya MORI, Osaka (JP)

(73) Assignee: Panasonic Automotive Systems Co., Ltd., Kanagawa (JP)

(21) Appl. No.: 18/965,391

(22) Filed: Dec. 2, 2024

(30) Foreign Application Priority Data
Dec. 12, 2023 (JP) 2023-209348

(51) Int. Cl. G02B 27/01; G03H 1/22

(52) U.S. Cl. CPC G02B 27/0103; G03H 1/2205; G02B 2027/0118

(57) ABSTRACT

An optical member includes: a hologram element that diffracts image light representing an image generated by an image light outputter and outputs the image light diffracted; and a light-transmissive portion in which the hologram element is provided. The hologram element includes a plurality of regions including a first region and a second region different from the first region. To inhibit luminance unevenness caused by an uneven surface of the light-transmissive portion, an uneven thickness of the light-transmissive portion, or an uneven distribution of the image light outputted by the image light outputter, the first region and the second region are different in at least one of diffraction efficiency of the hologram element, a deflection angle of the image light in the hologram element, or an optimum incident angle relative to the deflection angle.

### CROSS REFERENCE TO RELATED APPLICATION

The present application is based on and claims priority of Japanese Patent Application No. 2023-209348 filed on Dec. 12, 2023.

### FIELD

The present disclosure relates to an optical member, a display device, and a manufacturing method.

### BACKGROUND

Patent Literature (PTL) 1 discloses an optical device that is manufactured by exposing a hologram photosensitive material bonded on a transparent base member to laser light of a plurality of wavelengths from a fabrication light source to form, on the transparent base member, a hologram optical element having a plurality of diffraction peak wavelengths corresponding to the plurality of wavelengths.

### CITATION LIST

### Patent Literature

PTL 1: Japanese Patent No. 4720424

### SUMMARY

However, the optical device according to PTL 1 described above can be improved upon.

In view of this, the present disclosure provides an optical member, a display device, and a manufacturing method capable of improving upon the above related art.

An optical member according to an aspect of the present disclosure includes: a hologram element that diffracts image light representing an image generated by an image light outputter and outputs the image light diffracted; and a light-transmissive portion in which the hologram element is provided, wherein the hologram element includes a plurality of regions including a first region and a second region different from the first region, and to inhibit luminance unevenness caused by an uneven surface of the light-transmissive portion, an uneven thickness of the light-transmissive portion, or an uneven distribution of the image light outputted by the image light outputter, the first region and the second region are different in at least one of diffraction efficiency of the hologram element, a deflection angle of the image light in the hologram element, or an optimum incident angle relative to the deflection angle.

The optical member and so forth of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram showing an example of a vehicle in which a display device according to an embodiment is disposed.

FIG. 2 is a schematic diagram showing the display device and the vehicle according to the embodiment in a side view.

FIG. 3 is a perspective view showing the display device that uses a light guide plate according to the embodiment.

FIG. 4 is a diagram showing the display device that uses the light guide plate according to the embodiment.

FIG. 5 is a diagram showing the diffraction efficiency of the conventional hologram element that uses a light guide plate, the deflection angle and the incident angle of image light in the conventional hologram element, the diffraction efficiency of a hologram element in the case where the diffraction efficiency monotonically increases from one side to the other side of the hologram element, and the deflection angle and the incident angle of image light in the hologram element.

FIG. 6 is a diagram showing the diffraction efficiency of the conventional hologram element that uses the light guide plate, the deflection angle and the incident angle of image light in the conventional hologram element, the diffraction efficiency of the hologram element in the case where the diffraction efficiency monotonically increases from the central portion to edges of the hologram element, and the deflection angle and the incident angle of image light in the hologram element.

FIG. 7 is a diagram showing the diffraction efficiency of the conventional hologram element that uses the light guide plate, the deflection angle and the incident angle of image light in the conventional hologram element, the diffraction efficiency of the hologram element in the case where the diffraction efficiency repeats a monotonic increase and a monotonic decrease in the hologram element, and the deflection angle and the incident angle of image light in the hologram element.

FIG. 8 is another diagram showing the diffraction efficiency of the conventional hologram element that uses the light guide plate, the deflection angle and the incident angle of image light in the conventional hologram element, the diffraction efficiency of the hologram element in the case where the diffraction efficiency repeats a monotonic increase and a monotonic decrease in the hologram element, and the deflection angle and the incident angle of image light in the hologram element.

FIG. 9 is a diagram showing the diffraction efficiency of the conventional hologram element that uses the light guide plate, the deflection angle and the incident angle of image light in the conventional hologram element, the diffraction efficiency of the hologram element in the case of using the hologram element that includes a plurality of high and low regions, and the deflection angle and the incident angle of image light in the hologram element.

FIG. 10 is a diagram showing a display device that uses the light guide having an uneven thickness.

FIG. 11 is a diagram showing a display device that uses a combiner.

FIG. 12 is a diagram showing the diffraction efficiency of the conventional hologram element that uses a combiner, the deflection angle and the incident angle of image light in the conventional hologram element, the diffraction efficiency of the hologram element in the case where the diffraction efficiency monotonically increases from one side to the other side of the hologram element, and the deflection angle and the incident angle of image light in the hologram element.

FIG. 13 is a diagram showing the diffraction efficiency of the conventional hologram element that uses the combiner, the deflection angle and the incident angle of image light in the conventional hologram element, the diffraction efficiency of the hologram element in the case where the diffraction efficiency monotonically increases from the central portion to edges of the hologram element, and the deflection angle and the incident angle of image light in the hologram element.

FIG. 14 is a diagram showing the diffraction efficiency of the conventional hologram element that uses the combiner, the deflection angle and the incident angle of image light in the conventional hologram element, the diffraction efficiency of the hologram element in the case where the diffraction efficiency repeats a monotonic increase and a monotonic decrease in the hologram element, and the deflection angle and the incident angle of image light in the hologram element.

FIG. 15 is another diagram showing the diffraction efficiency of the conventional hologram element that uses the combiner, the deflection angle and the incident angle of image light in the conventional hologram element, the diffraction efficiency of the hologram element in the case where the diffraction efficiency repeats a monotonic increase and a monotonic decrease in the hologram element, and the deflection angle and the incident angle of image light in the hologram element.

FIG. 16 is a diagram showing the diffraction efficiency of the conventional hologram element that uses the combiner, the deflection angle and the incident angle of image light in the conventional hologram element, the diffraction efficiency of the hologram element in the case of using the hologram element that includes a plurality of high and low regions, and the deflection angle and the incident angle of image light in the hologram element.

FIG. 17 is a flowchart showing a manufacturing method of manufacturing an optical member.

### DESCRIPTION OF EMBODIMENT

Hereinafter, a certain exemplary embodiment is described in greater detail with reference to the accompanying Drawings.

The exemplary embodiment described below shows a general or specific example. The numerical values, shapes, materials, elements, the arrangement and connection of the elements, steps, the processing order of the steps etc. shown in the following exemplary embodiment are mere examples, and therefore do not limit the scope of the present disclosure. Therefore, among the elements in the following exemplary embodiment, those not recited in any one of the independent claims are described as optional elements.

Note that the drawings are schematic diagrams, and thus they are not always exactly illustrated. Also, the same elements are assigned the same reference marks throughout the drawings.

The following embodiment uses expressions such as “a rectangular shape”, “approximately parallel, “in the X-axis direction” etc. These expressions mean not only completely “a rectangular shape”, “parallel”, and “in the X-axis direction”, but also mean substantially “a rectangular shape”, “parallel”, and “in the X-axis direction”. Stated differently, these expressions mean that an error on the order of a few percent, for example, is allowed. These expressions mean “a rectangular shape”, “approximately parallel”, “in the X-axis direction” within the scope in which the effects of the present disclosure are achievable. This is applicable to other expressions using “XX shape”, “approximately”, and “direction”.

### EMBODIMENT

### <Configuration>

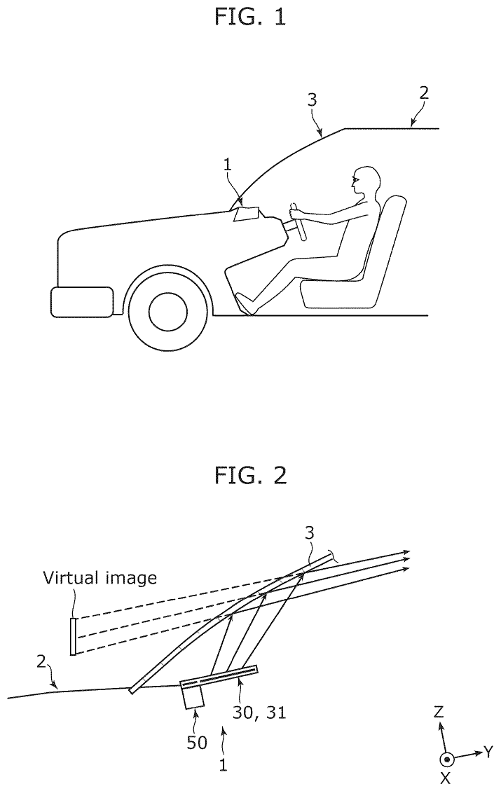

First, with reference to FIG. 1 to FIG. 4, the configuration of display device 1 is described.

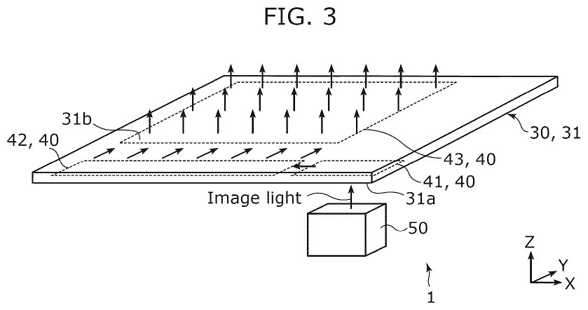

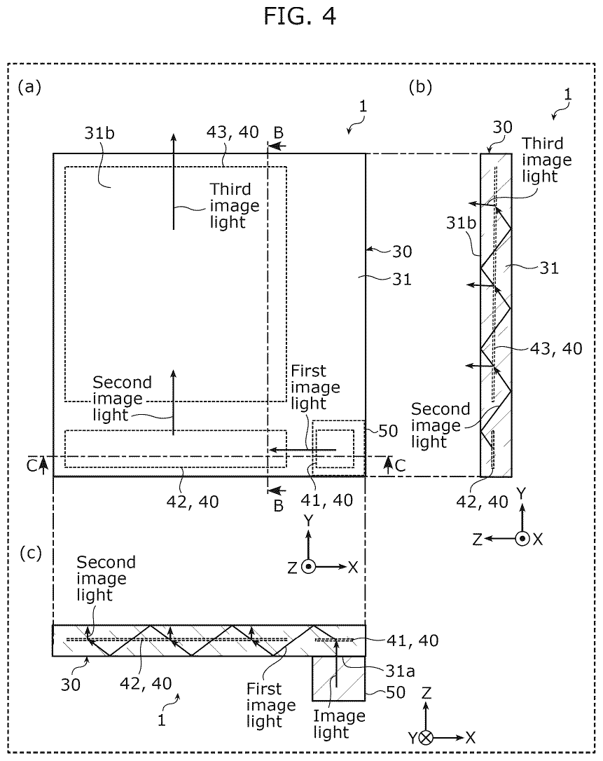

FIG. 1 is a schematic diagram showing an example of vehicle 2 in which display device 1 according to an embodiment is disposed. FIG. 2 is a schematic diagram showing display device 1 and vehicle 2 according to the embodiment in a side view. FIG. 3 is a perspective view showing display device 1 that uses a light guide plate according to the embodiment. FIG. 4 is a diagram showing display device 1 that uses the light guide plate according to the embodiment. In FIG. 4, (a) shows a front view of display device 1, (b) shows a cross-sectional view of display device 1 along line B-B in (a) in FIG. 4, and (c) shows a cross-sectional view of display device 1 along line C-C in (a) in FIG. 4.

As shown in FIG. 1 and FIG. 2, display device 1 outputs image light to a light reflector to cause the image light to be reflected at the light reflector, thereby enabling the image light to enter the eyes of a person. When used in vehicle 2, for example, display device 1 is capable of causing image light that is outputted to front window 3 serving as a light-transmissive member to be reflected, thereby enabling the image light to enter the eyes of a person. In this case, display device 1 outputs the image light to project an image represented by such image light onto the light-transmissive member, thereby displaying a virtual image corresponding to the image onto the light-transmissive member. The image light is light representing an image and intended to display a virtual image in a forward direction of front window 3. The image is a still image or a moving image, and is an image showing, for example, numeric characters, texts, graphics, etc.

As shown in FIG. 2 and FIG. 3, display device 1 includes image light outputter 50 and optical member 30. FIG. 2 and FIG. 3 show an example case where light guide 31 (light guide plate) through which image light propagates serves as the light-transmissive portion.

Image light outputter 50 is an image generating device that outputs image light to optical member 30. Image light outputter 50 outputs image light representing an image having a rectangular shape, thereby projecting the image light onto front window 3 via optical member 30. With this, a virtual image is recognized by the user.

Image light outputter 50 as described above includes a plurality of emitters, a plurality of dichroic mirrors, a condenser lens, a plurality of mirrors, and an output surface.

The plurality of emitters output light beams in predetermined wavelength bands that are mutually different. The plurality of dichroic mirrors are disposed in the optical path of the light beams outputted by the plurality of emitters and each capable of reflecting a light beam in the predetermined wavelength band and transmitting light beams in the other wavelength bands. The condenser lens is a lens that condenses the light beams outputted via the plurality of dichroic mirrors onto the plurality of mirrors. The output surface is, for example, a screen such as a microlens array, a liquid crystal display device such as a liquid crystal on silicon (LCOS), etc. When irradiated with the light beams of a plurality of wavelength bands from the mirror side, the output surface outputs the transmitted light beams as image light toward optical member 30.

Optical member 30 is a hologram light guide plate that displays, to the user, the image represented by the image light. Optical member 30 has a light-transmission property and is capable of enlarging the image, which is represented by the image light outputted by image light outputter 50, in the X-axis direction and the Y-axis direction, and outputting the enlarged image. Optical member 30 is disposed to face image light outputter 50 and front window 3.

Optical member 30 includes incident surface 31a and output surface 31b.

Incident surface 31a is disposed to face the output surface of image light outputter 50. The image light outputted from the output surface of image light outputter 50 enters incident surface 31a. Incident surface 31a is part of the back surface of optical member 30 having a rectangular shape. The back surface is the surface of optical member 30 located on the opposite side of output surface 31b.

The image light that has entered from incident surface 31a and propagated inside optical member 30 is outputted from output surface 31b toward front window 3. Output surface 31b faces front window 3 and is spaced a predetermined distance apart from front window 3. Output surface 31b is part of the top surface of optical member 30.

As shown in FIG. 4, optical member 30 includes light guide 31 having a light-transmission property, and one or more hologram elements 40. The present embodiment shows an example in which optical member 30 includes a plurality of hologram elements 40.

Incident surface 31a that faces image light outputter 50 is provided in light guide 31. Incident surface 31a is the surface that faces image light outputter 50 and is part of the back surface of light guide 31. Output surface 31b is also provided in light guide 31 to face front window 3. Output surface 31b is part of the top surface of light guide 31.

Light guide 31 is configured, using a light-transmissive material such as glass, resin material, etc.

Light guide 31 internally includes a plurality of hologram elements 40 that diffract the image light representing the image generated by image light outputter 50 and output the diffracted image light. As shown in FIG. 4, the plurality of hologram elements 40 are light-transmissive optical elements that diffract light propagating inside light guide 31 and output the diffracted light. The plurality of hologram elements 40 are internally included in light guide 31 in an orientation that is approximately parallel to incident surface 31a and output surface 31b of light guide 31. The plurality of hologram elements 40 are configured, using a light-transmissive material.

Such plurality of hologram elements 40 include input hologram element 41, folding hologram element 42, and output hologram element 43. Note that input hologram element 41, folding hologram element 42, and output hologram element 43 can be collectively referred to simply as “hologram elements 40”.

Input hologram element 41 and folding hologram element 42 are disposed side-by-side in the X-axis direction. Folding hologram element 42 and output hologram element 43 are disposed side-by-side in the Y-axis direction. Input hologram element 41 is disposed to overlap incident surface 31a of optical member 30 when viewed in the Z-axis direction, and overlap the output surface of image light outputter 50 that is disposed on the negative Z-axis direction side of optical member 30. Input hologram element 41 is disposed on the positive X-axis direction side of folding hologram element 42 and closer to the light-incident side of optical member 30 than folding hologram element 42 is.

Input hologram element 41 is hologram element 40 from which the image light outputted by image light outputter 50 enters. Input hologram element 41 is an example of the first hologram element.

The image light outputted from the output surface of image light outputter 50 and traveling in the positive Z-axis direction enters input hologram element 41. Input hologram element 41 outputs, toward folding hologram element 42, the image light that has entered. More specifically, input hologram element 41 deflects the image light that has entered optical member 30, by diffracting such image light in accordance with the diffraction efficiency of input hologram element 41, when the image light propagates inside optical member 30. Through this, input hologram element 41 outputs the image light as first image light (deflected light) that propagates in the negative X-axis direction. The first image light deflected by the diffraction performed by input hologram element 41 enters folding hologram element 42.

Folding hologram element 42 is disposed on the negative X-axis direction side of input hologram element 41, which is the light-output side of input hologram element 41, and is disposed on the negative Y-axis direction side of output hologram element 43 and closer to the light-incident side of optical member 30 than output hologram element 43 is.

Folding hologram element 42 is hologram element 40 that is long in the X-axis direction, and diffracts the first image light outputted by input hologram element 41 to output second image light to output hologram element 43. Folding hologram element 42 is an example of the first hologram element or the second hologram element.

Every time the first image light transmitted through input hologram element 41 enters (transmits) folding hologram element 42, folding hologram element 42 outputs, toward output hologram element 43, the second image light (deflected light), which is obtained by further deflecting, by diffraction, the first image light that has entered. More specifically, folding hologram element 42 further deflects the first image light that has entered folding hologram element 42 by diffracting the first image light in accordance with the diffraction efficiency of folding hologram element 42, when such first image light propagates inside optical member 30 in the negative X-axis direction. To inhibit luminance unevenness, folding hologram element 42 is configured such that the diffraction efficiency becomes greater as the distance from input hologram element 41 increases. At this time, folding hologram element 42 enlarges the image of the first image light in the X-axis direction. With this, folding hologram element 42 outputs, in the positive Y-axis direction, the second image light obtained by enlarging the image of the first image light in the X-axis direction. The second image light deflected by the diffraction performed by folding hologram element 42 enters output hologram element 43.

Output hologram element 43 is disposed closer to the positive Y-axis direction side, which is the light-output side of folding hologram element 42, than folding hologram element 42 is. Also, output hologram element 43 is disposed to overlap and face output surface 31b of optical member 30.

Output hologram element 43 is hologram element 40 having a rectangular shape when viewed in the Z-axis direction. Output hologram element 43 is an example of the second hologram element. Every time the second image light transmitted through folding hologram element 42 enters (transmits) output hologram element 43, output hologram element 43 outputs, at a predetermined output angle, third image light (deflected light), which is obtained by further deflecting, by diffraction, the second image light that has entered. More specifically, output hologram element 43 further deflects the second image light, which has been deflected by the diffraction performed by folding hologram element 42, by diffracting the second image light in accordance with the diffraction efficiency of output hologram element 43, when such second image light propagates inside optical member 30 in the positive Y-axis direction. To inhibit luminance unevenness, output hologram element 43 is configured such that the diffraction efficiency becomes greater as the distance from folding hologram element 42 increases. At this time, output hologram element 43 enlarges the image of the second image light, which has been enlarged in the X-axis direction, further approximately in the Y-axis direction. With this, output hologram element 43 outputs, at the predetermined output angle, the third image light obtained by enlarging the image of the second image light in the X-axis direction and approximately in the Y-axis direction, to outside optical member 30. Stated differently, output hologram element 43 enlarges the second image light outputted by folding hologram element 42 further approximately in the Y-axis direction, thereby outputting, at the predetermined output angle, the third image light obtained by enlarging the image of the second image light in the X-axis direction and the Y-axis direction. In the present embodiment, output hologram element 43 outputs the third image light in the positive Z-axis direction such that the third image light is oriented toward front window 3.

Here, the predetermined output angle is the output angle of the third image light outputted from the output surface of output hologram element 43, and is an angle of outgoing light relative to the normal of the output surface of output hologram element 43.

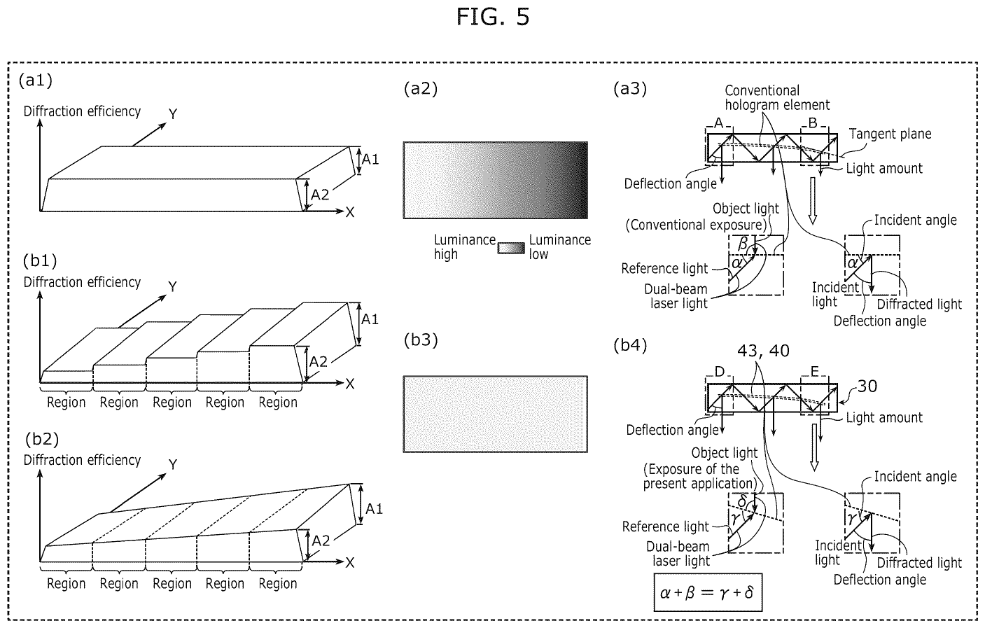

With reference to FIG. 5 to FIG. 10, the following describes a specific configuration of hologram elements 40.

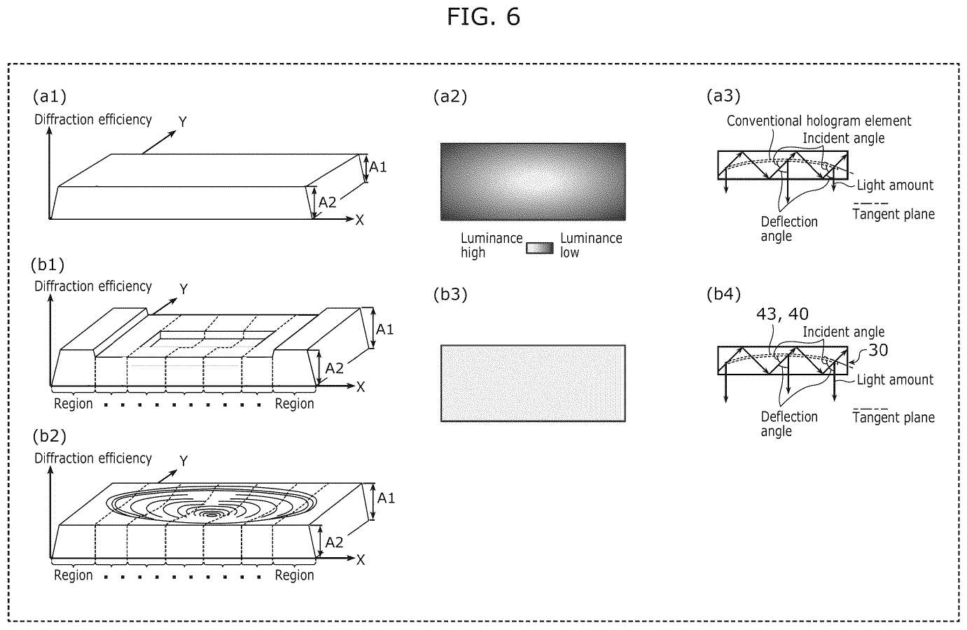

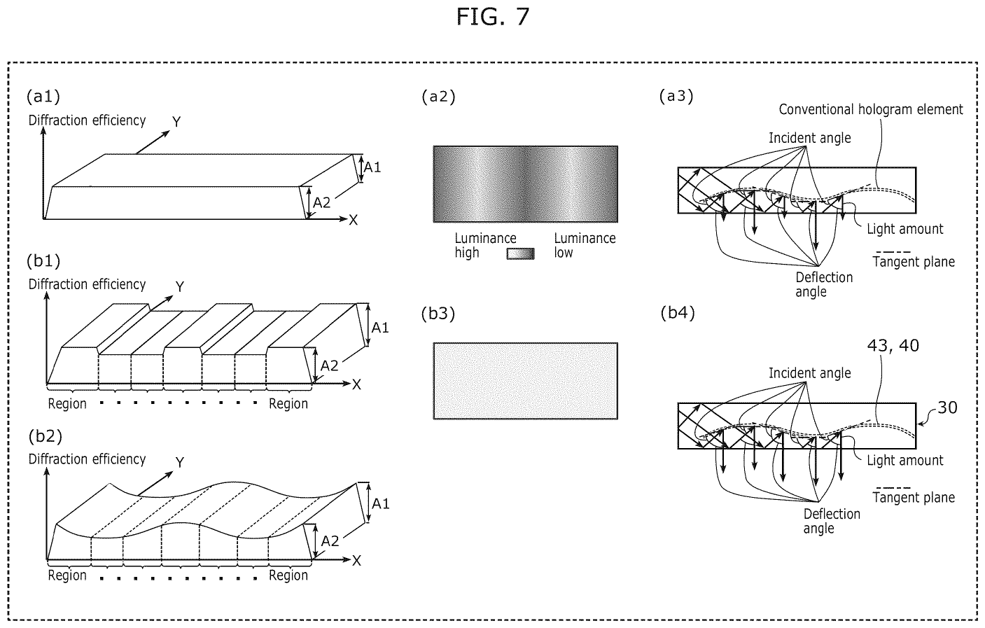

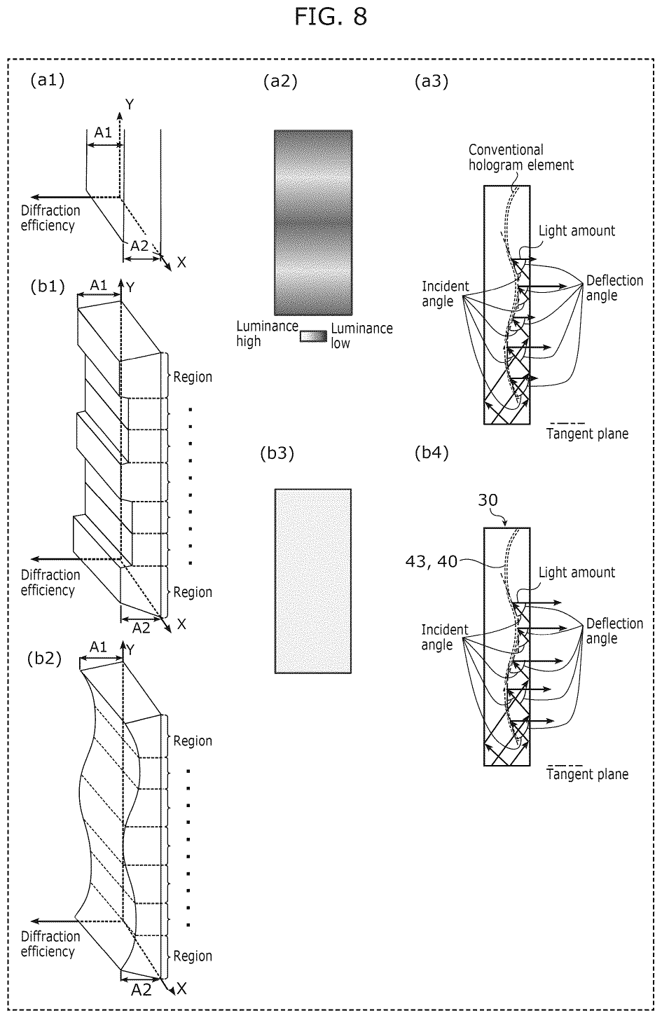

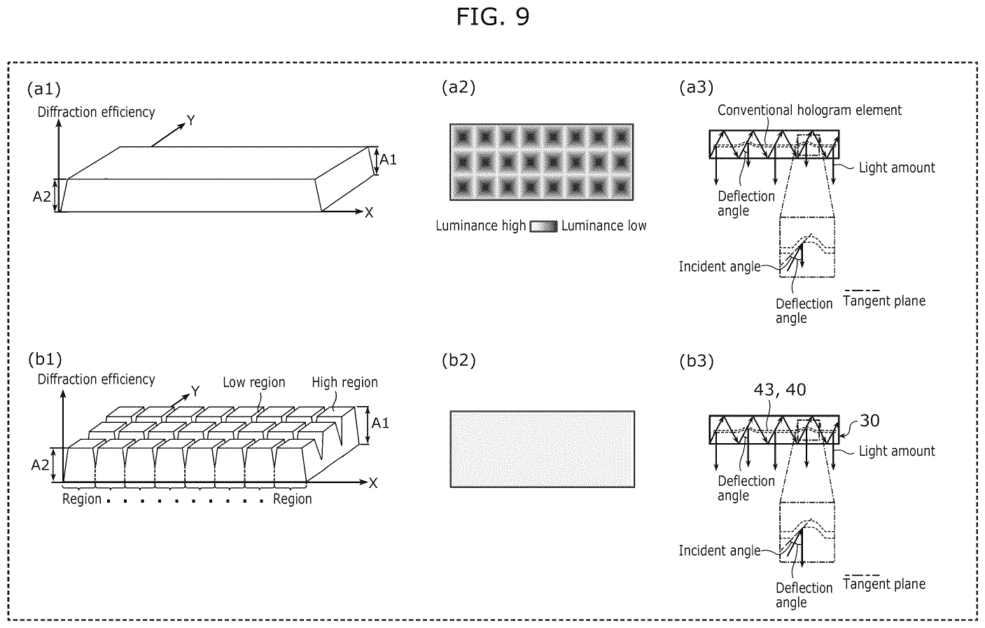

FIG. 5 is a diagram showing the diffraction efficiency of the conventional hologram element that uses a light guide plate, the deflection angle and the incident angle of image light in the conventional hologram element, the diffraction efficiency of hologram element 40 in the case where the diffraction efficiency monotonically increases from one side to the other side of hologram element 40, and the deflection angle and the incident angle of image light in hologram element 40. Note that “from one side to the other side” may be any directions, and thus may be, for example, any one of the positive X-axis direction, the negative X-axis direction, the positive Y-axis direction, the negative Y-axis direction, the positive Z-axis direction, and the negative Z-axis direction. Note that (a3) and (b4) in FIGS. 5, (a3) and (b4) in FIGS. 6, (a3) and (b4) in FIGS. 7, (a3) and (b4) in FIG. 8, and (a3) and (b3) in FIG. 9, the light guide plate (optical member 30) is actually curved to fit curved hologram element 40. To simplify optical member 30 to avoid complication of the drawings, however, optical member 30 having a flat shape is shown in the drawings.

In FIG. 5, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element. Each light amount is indicated by the length of an arrow. The same is applicable to the subsequent drawings.

In FIG. 5, (b1) shows the diffraction efficiency of hologram element 40 that nonlinearly increases, (b2) shows the diffraction efficiency of hologram element 40 that linearly increases, and (b3) shows the luminance that has been made even by optical member 30 in the case of using hologram element 40.

In FIG. 5, (b4) shows the deflection angle and the incident angle of image light that monotonically increase in curved hologram element 40, and the light amount of light outputted from curved hologram element 40. Each light amount is indicated by the length of an arrow.

In FIGS. 5, (a1), (b1), and (b2) show the case where the diffraction efficiency decreases toward the negative Y-axis direction. In output hologram element 43, for example, diffraction efficiency A2 on the negative Y-axis direction side is smaller than diffraction efficiency A1 on the positive Y-axis direction side. Note that in input hologram element 41 and folding hologram element 42, diffraction efficiency A2 on the negative Y-axis direction side is the same as diffraction efficiency A1 on the positive Y-axis direction side. The same is applicable to the subsequent drawings.

Note that in (b1) and (b2) in FIG. 5, the diffraction efficiency of hologram element 40 changes more toward the positive X-axis direction, but the present embodiment is not limited to this. Thus, the optimum incident angle relative to the deflection angle in hologram element 40 may change more toward the positive X-axis direction. Stated differently, at least one of the diffraction efficiency or the optimum incident angle relative to the deflection angle in hologram element 40 may change more toward the positive X-axis direction.

Also, in FIG. 5, a plurality of regions are arranged in the X-axis direction, but the present embodiment is not limited to this. The plurality of regions may be arranged not only in the X-axis direction, but also in the Y-axis direction. Stated differently, at least one of the diffraction efficiency of hologram element 40 or the optimum incident angle relative to the deflection angle in hologram element 40 may change in the plurality of regions not only in one direction but also in two directions.

FIG. 6 is a diagram showing the diffraction efficiency of the conventional hologram element that uses the light guide plate, the deflection angle and the incident angle of image light in the conventional hologram element, the diffraction efficiency of hologram element 40 in the case where the diffraction efficiency monotonically increases from the central portion to edges of hologram element 40, and the deflection angle and the incident angle of image light in hologram element 40.

In FIG. 6, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element.

In FIG. 6, (b1) shows the diffraction efficiency of hologram element 40 that nonlinearly increases, (b2) shows the diffraction efficiency of hologram element 40 that monotonically increases, (b3) shows the luminance that has been made even by optical member 30 in the case of using hologram element 40, and (b4) shows the deflection angle and the incident angle of image light that monotonically increase in curved hologram element 40, and the light amount of light outputted from curved hologram element 40.

FIG. 7 is a diagram showing the diffraction efficiency of the conventional hologram element that uses the light guide plate, the deflection angle and the incident angle of image light in the conventional hologram element, the diffraction efficiency of hologram element 40 in the case where the diffraction efficiency repeats a monotonic increase and a monotonic decrease in hologram element 40, and the deflection angle and the incident angle of image light in hologram element 40.

In FIG. 7, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element.

In FIG. 7, (b1) shows the diffraction efficiency of hologram element 40 that repeats a monotonic increase and a monotonic decrease in the X-axis direction, (b2) shows another diffraction efficiency of hologram element 40 that repeats a monotonic increase and a monotonic decrease in the X-axis direction, (b3) shows the luminance that has been made even by optical member 30 in the case of using hologram element 40, and (b4) shows the deflection angle and the incident angle of image light that repeat a monotonic increase and a monotonic decrease in waved hologram element 40, and the light amount of light outputted from waved hologram element 40.

Note that in FIG. 7, the plurality of regions are arranged in the X-axis direction, but the present embodiment is not limited to this. The plurality of regions may also be arranged not only in the X-axis direction, but also in the Y-axis direction. Stated differently, at least one of the diffraction efficiency of hologram element 40 or the optimum incident angle relative to the deflection angle in hologram element 40 may change in the plurality of regions not only in one direction but also in two directions.

FIG. 8 is another diagram showing the diffraction efficiency of the conventional hologram element that uses the light guide plate, the deflection angle and the incident angle of image light in the conventional hologram element, the diffraction efficiency of hologram element 40 in the case where the diffraction efficiency repeats a monotonic increase and a monotonic decrease in hologram element 40, and the deflection angle and the incident angle of image light in hologram element 40.

In FIG. 8, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element.

In FIG. 8, (b1) shows the diffraction efficiency of hologram element 40 that repeats a monotonic increase and a monotonic decrease in the Y-axis direction, (b2) shows another diffraction efficiency of hologram element 40 that repeats a monotonic increase and a monotonic decrease in the Y-axis direction, (b3) shows the luminance that has been made even by optical member 30 in the case of using hologram element 40, and (b4) shows the deflection angle and the incident angle of image light that repeat a monotonic increase and a monotonic decrease in waved hologram element 40, and the light amount of light outputted from waved hologram element 40.

Note that in FIG. 8, the plurality of regions are arranged in the Y-axis direction, but the present embodiment is not limited to this. The plurality of regions may also be arranged not only in the Y-axis direction, but also in the X-axis direction. Stated differently, at least one of the diffraction efficiency of hologram element 40 or the optimum incident angle relative to the deflection angle in hologram element 40 may change in the plurality of regions not only in one direction but also in two directions.

FIG. 9 is a diagram showing the diffraction efficiency of the conventional hologram element that uses the light guide plate, the deflection angle and the incident angle of image light in the conventional hologram element, the diffraction efficiency of hologram element 40 in the case of using hologram element 40 that includes a plurality of high and low regions, and the deflection angle and the incident angle of image light in hologram element 40.

In FIG. 9, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element.

In FIG. 9, (b1) shows the diffraction efficiency of hologram element 40 in which the plurality of high and low regions arranged in a matrix pattern are formed, (b2) shows the luminance that has been made even by optical member 30 in the case of using hologram element 40 in which the plurality of high and low regions arranged in a matrix pattern are formed, and (b3) shows the deflection angle and the incident angle of image light in hologram element 40 in which the plurality of high and low regions arranged in a matrix pattern are formed, and the light amount of light outputted from hologram element 40 in which the plurality of high and low regions arranged in a matrix pattern are formed.

Note that in FIG. 9, at least one of the diffraction efficiency of hologram element 40 or the optimum incident angle relative to the deflection angle in hologram element 40 may change in the plurality of regions not only in one direction but also in two directions. Also, the plurality of high and low regions arranged in a matrix pattern may be nonlinearly connected.

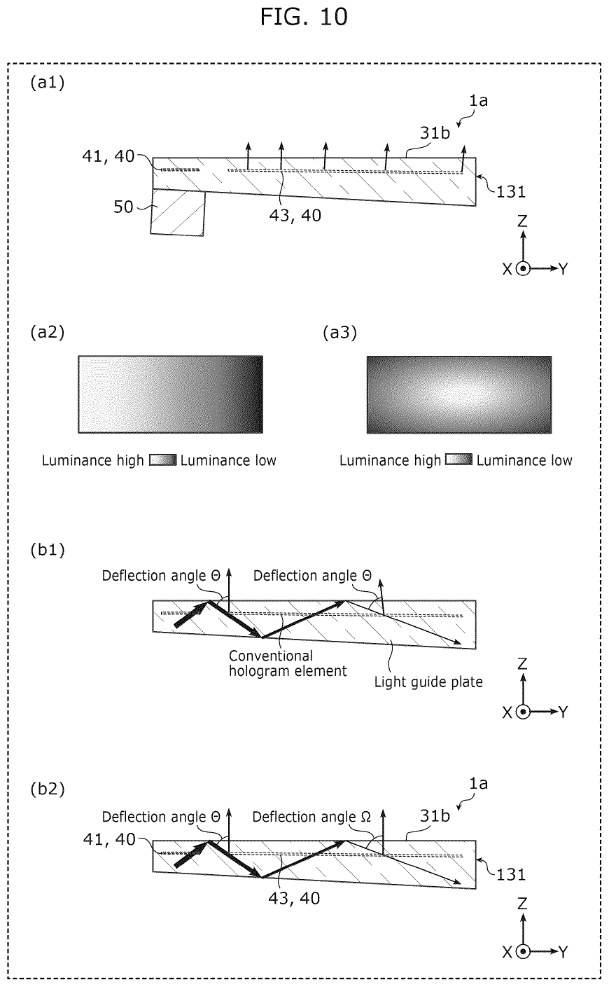

FIG. 10 is a diagram showing display device 1a that uses light guide 131 having an uneven thickness. In FIG. 10, (a1) shows light guide 131 having an uneven thickness, (a2) shows luminance unevenness that occurs in the case of using light guide 131 having an uneven thickness, (a3) shows luminance unevenness that occurs due to an uneven distribution of image light outputted by image light outputter 50. In FIG. 10, (b1) shows the deflection angles of image light in the conventional hologram element, and the light amount of light outputted from the conventional hologram element, (b2) shows the deflection angles of image light in hologram element 40 internally included in light guide 131 having an uneven thickness, and the light amount of light outputted from such hologram element 40. In (b1) and (b2) in FIG. 10, the light amount of light guided in the light guide plate and the light amount of light guided in light guide 131 are indicated by the thickness of solid lines.

As shown in (b1) to (b4) in FIG. 5, hologram element 40 includes the plurality of regions. The plurality of regions include a first region and a second region different from the first region. The first region and the second region differ, in the X-axis direction or the Y-axis direction, in at least one of the diffraction efficiency of hologram element 40 or the optimum incident angle relative to the deflection angle of image light in hologram element 40. The first region and a third region that is different from the first region and the second region, differ, in the Y-axis direction or the X-axis direction, in at least one of the diffraction efficiency of hologram element 40 or the optimum incident angle relative to the deflection angle of image light in hologram element 40. For example, the diffraction efficiency and the optimum incident angle relative to the deflection angle of image light may undergo a first monotonic increase from the first region to the second region, and the diffraction efficiency and the optimum incident angle relative to the deflection angle of image light may undergo a second monotonic increase from the first region to the third region. The increase patterns of the first monotonic increase and the second monotonic increase may be the same or different. The X-axis direction or the Y-axis direction is an example of the first direction. The Y-axis direction or the X-axis direction is an example of the second direction. The first direction is a direction that is different from the second direction and that is orthogonal to the second direction in the present embodiment.

Each of the plurality of regions is a cell at which image light is diffracted and from which the diffracted image light is outputted. The size of the cells is on the order of hundreds of microns.

To inhibit luminance unevenness caused by an uneven surface of light guide 31, an uneven thickness of light guide 31, or an uneven distribution of image light outputted by image light outputter 50, the first region and the second region are different at least in one of the diffraction efficiency of hologram element 40 or the optimum incident angle relative to the deflection angle of image light in hologram element 40.

When the surface of light guide 31 is uneven, for example, hologram element 40 may be formed to inhibit luminance unevenness caused by the uneven surface of light guide 31 and to adjust at least one of the diffraction efficiency of hologram element 40 or the optimum incident angle relative to the deflection angle of image light in hologram element 40. That the surface of light guide 31 is uneven refers to the case such as where the roughness of the surface of light guide 31 is uneven, asperities are present on the surface of light guide 31, etc. Stated differently, the plurality of regions for adjusting at least one of the diffraction efficiency of hologram element 40 or the optimum incident angle relative to the deflection angle of image light in hologram element 40 are formed in hologram element 40 to inhibit luminance unevenness caused by the uneven surface of light guide 31.

When the thickness of light guide 131 is uneven, as shown (a1) and (a2) in FIG. 10, for example, hologram element 40 may be formed to inhibit luminance unevenness caused by the uneven thickness of light guide 131 and to adjust the deflection angle of image light in hologram element 40. That the thickness of light guide 31 is uneven refers to the case such as where the thickness of light guide 31 gradually increases or decreases from one side to the other side of light guide 131, the thickness of the central portion of light guide 131 is greater or smaller than the thickness of the peripheral portion of light guide 131, etc. (a1) in FIG. 10 shows an example case where the thickness of light guide 131 gradually increases from the input hologram element 41 side and the folding hologram element 42 side of light guide 131 toward output hologram element 43. In this case, since the angle of light that propagates inside the light guide plate changes, as shown in (b1) in FIG. 10, the angle at which the light enters the hologram element changes in the Y-axis direction. As a result, the angle at which the light that is diffracted at deflection angle θ is outputted from the hologram element also changes in the Y-axis direction. In contrast, when deflection angle θ of hologram element 40 is replaced by deflection angle 22 in accordance with the angle of light that propagates inside light guide 131, as shown in (b2) in FIG. 10, it is possible to make the angle at which light is outputted from hologram element 40 constant even when the angle at which the light enters hologram element 40 differs. Stated differently, the plurality of regions for adjusting the deflection angle of the image light in hologram element 40 are formed in hologram element 40 to inhibit luminance unevenness caused by the uneven thickness of light guide 131.

When the thickness of light guide 131 is uneven and the distribution of the image light outputted by image light outputter 50 is also uneven, as shown in (a1) to (a3) in FIG. 10, for example, hologram element 40 is formed to inhibit luminance unevenness caused by the uneven distribution of the image light outputted by image light outputter 50 and to adjust at least one of the diffraction efficiency of hologram element 40 or the deflection angle of image light in hologram element 40, in consideration of the luminance unevenness caused by the uneven thickness of light guide 131. That the distribution of the image light is uneven refers to the case such as where the intensity distribution of the image light outputted from the output surface of image light outputter 50 is uneven, etc., as shown in (a3) in FIG. 10. Stated differently, the plurality of regions for adjusting at least one of the diffraction efficiency of hologram element 40 or the deflection angle of image light in hologram element 40 are formed in hologram element 40 to inhibit luminance unevenness caused by the uneven distribution of the image light outputted by image light outputter 50. For example, the plurality of regions may be formed to cause at least one of the diffraction efficiency of hologram element 40 or the deflection angle of image light in hologram element 40 to monotonically change in the positive Y-axis direction.

Here, with reference to FIG. 5 to FIG. 10, a specific example case is described where at least one of the diffraction efficiency of hologram element 40, the deflection angle of image light in hologram element 40, or the optimum incident angle relative to the deflection angle is different.

First, as shown in (b1) to (b4) in FIG. 5, the plurality of regions may be formed in hologram element 40 to cause at least one of the diffraction efficiency of hologram element 40 or the optimum incident angle relative to the deflection angle of image light in hologram element 40 to monotonically change from one side to the other side of hologram element 40.

As shown in (b2) and (b4) in FIG. 5, for example, the plurality of regions may be formed in hologram element 40 to cause at least one of the diffraction efficiency of hologram element 40 or the optimum incident angle relative to the deflection angle of image light in hologram element 40 to linearly change from one side to the other side of hologram element 40. “To linearly change” indicates to change in a linear manner. For this reason, it is indicated that at least one of the diffraction efficiency of hologram element 40 or the optimum incident angle relative to the deflection angle of image light in hologram element 40 continuously changes from one side to the other side of hologram element 40 in each of the plurality of regions. When the conventional hologram element has a curved shape, as shown in (a3) in FIG. 5, for example, image light whose incident angle is different from the incident angles at which laser beams used for dual-beam exposure enter. As such, the angles at which these light beams are diffracted are different. For this reason, an area occurs where the light amount of image light diffracted by the conventional hologram element and outputted from optical member 30 is reduced. More specifically, the diffraction efficiency in position A indicated by the two-dotted line shown in (a3) in FIG. 5 is high, but the diffraction efficiency in position B indicated by the two-dotted line is lower than the diffraction efficiency in position A, because the tangent plane of the conventional hologram element is tilted with respect to the horizontal plane. This is because, in the conventional hologram element, as shown in the relationship between angle α and angle β indicated by the conventional dual-beam exposure using laser light (the relationship between incident angle α formed by reference light and incident angle β formed by object light), dual-beam exposure using laser light is performed in the same manner at any positions. As such, the angle formed between the tangent plane and the incident light is different from that in position A, making it difficult to efficiently obtain diffracted light. Consequently, it is impossible to make image light outputted from the optical member uniform, making it difficult to obtain the desired image light.

In view of this, in (b4) in FIG. 5, dual-beam exposure using laser light is performed at an angle γ and angle δ suitable for position E to differentiate from position D indicated by the two-dotted line, thereby achieving diffraction efficiency also in position E that is as high as the diffraction efficiency in position D and adjusting the deflection angle. More specifically, by subjecting position E to dual-beam exposure using laser light at an angle γ and angle δ (the relationship between incident angle γ formed by the reference light and incident angle δ formed by the object light) suitable for position E indicated by the two-dotted line, it is possible to achieve diffraction efficiency in position E that is as high as the diffraction efficiency in position D and to adjust the deflection angle. For example, in the present disclosure, it is possible to make image light outputted from optical member 30 uniform in an area where the amount of image light diffracted by the conventional hologram element and outputted from the optical member is small, as shown in (a3) in FIG. 5, by subjecting output hologram element 43 to dual-beam exposure using laser light such that the relationship between the incident angle and the output angle relative to output hologram element 43 changes, as shown in (b4) in FIG. 5. Note that a relational expression α+B=γ+δ is established among angle α, angle β, angle γ, and angle δ here.

In (a3) and (b4) in FIG. 5, the tangent plane that is tangent to the conventional hologram element and the tangent plane that is tangent to hologram element 40, respectively, are indicated by the single-dotted lines. The tangent planes are indicated by single-dotted lines in the same manner in the subsequent drawings.

The plurality of regions may be formed in hologram element 40, as shown in (b1) and (b4) in FIG. 5, for example, to cause at least one of the diffraction efficiency of hologram element 40 or the optimum incident angle relative to the deflection angle of image light in hologram element 40 to nonlinearly change from one side to the other side of hologram element 40. “To nonlinearly change” indicates a change other than linear change, which is, for example, stepwise change, exponential or logarithmic continuous arc-like change.

In the case of stepwise change, at least one of the diffraction efficiency of hologram element 40 or the optimum incident angle relative to the deflection angle of image light in hologram element 40 may be constant in each of the plurality of regions. More specifically, when the diffraction efficiency is constant, the plurality of regions may be formed in hologram element 40 such that the diffraction efficiency of hologram element 40 is constant in each region and changes stepwise from one side to the other side of hologram element 40. When the optimum incident angle relative to the deflection angle is constant, the plurality of regions may be formed in hologram element 40 such that the optimum incident angle relative to the deflection angle of image light in hologram element 40 is constant in each region and increases stepwise from one side to the other side of hologram element 40.

In the case of continuous arc-like change, at least one of the diffraction efficiency of hologram element 40 or the optimum incident angle relative to the deflection angle of image light in hologram element 40 may continuously change in each of the plurality of regions. More specifically, the plurality of regions may be formed in hologram element 40 such that at least one of the diffraction efficiency of hologram element 40 or the optimum incident angle relative to the deflection angle of image light in hologram element 40 continuously changes in an arc-like manner from one side to the other side of hologram element 40.

In the optical member that uses the conventional hologram element, as shown in (a1) to (a3) in FIG. 5, the diffraction efficiency and the optimum incident angle relative to the deflection angle are the same at any positions. For this reason, when the incident angle of image light relative to the hologram element differs, the image light cannot be diffracted sufficiently and a portion occurs where the light amount of image light outputted from the conventional hologram element is reduced. This results in luminance unevenness. However, as shown in (b1) to (b4) in FIG. 5, optical member 30 using hologram element 40 of the present disclosure is capable of inhibiting luminance unevenness caused by the uneven surface of the light-transmissive portion and the uneven thickness of the light-transmissive portion.

Next, as shown in (b1) and (b4) in FIG. 6, the plurality of regions may be formed in hologram element 40 to cause at least one of the diffraction efficiency of hologram element 40 or the optimum incident angle relative to the deflection angle of image light in hologram element 40 to monotonically change from the central portion to edges of hologram element 40.

For example, as shown in (b1), (b2), and (b4) in FIG. 6, the plurality of regions may be formed in hologram element 40 to cause at least one of the diffraction efficiency of hologram element 40 or the optimum incident angle relative to the deflection angle of image light in hologram element 40 to nonlinearly change from the central portion to edges of hologram element 40.

In the case of stepwise change, at least one of the diffraction efficiency of hologram element 40 or the optimum incident angle relative to the deflection angle of image light in hologram element 40 may be constant in each of the plurality of regions. More specifically, when the diffraction efficiency is constant, the plurality of regions may be formed in hologram element 40 such that the diffraction efficiency of hologram element 40 is constant in each region and changes stepwise from the central portion to edges of hologram element 40. When the optimum incident angle relative to the deflection angle is constant, the plurality of regions may be formed in hologram element 40 such that the optimum incident angle relative to the deflection angle of image light in hologram element 40 is constant in each region and changes stepwise from the central portion to edges of hologram element 40.

In the case of continuous arc-like change, at least one of the diffraction efficiency of hologram element 40 or the optimum incident angle relative to the deflection angle of image light in hologram element 40 may continuously change in each of the plurality of regions. More specifically, the plurality of regions may be formed in hologram element 40 such that at least one of the diffraction efficiency of hologram element 40 or the optimum incident angle relative to the deflection angle of image light in hologram element 40 continuously changes in an arc-like manner from the central portion to edges of hologram element 40.

For example, the plurality of regions may be formed in hologram element 40 to cause at least one of the diffraction efficiency of hologram element 40 or the optimum incident angle relative to the deflection angle of image light in hologram element 40 to linearly change from the central portion to edges of hologram element 40.

In this case, too, it is indicated that at least one of the diffraction efficiency of hologram element 40 or the optimum incident angle relative to the deflection angle of image light in hologram element 40 continuously changes in each of the plurality of regions from the central portion to edges of hologram element 40.

In the optical member using the conventional hologram element, as shown in (a1) to (a3) in FIG. 6, the diffraction efficiency and the optimum incident angle relative to the deflection angle are the same at any positions. For this reason, when the incident angle of image light relative to the hologram element differs, the image light cannot be diffracted sufficiently and a portion occurs where the light amount of image light outputted from the conventional hologram element is reduced. This results in luminance unevenness. However, as shown in (b1) to (b4) in FIG. 6, optical member 30 using hologram element 40 of the present disclosure is capable of inhibiting luminance unevenness caused by the unevenness in the surface of the light-transmissive portion and the unevenness in the internal thickness of the light-transmissive portion.

Next, as shown in (b1) to (b4) in FIG. 7 and in (b1) to (b4) in FIG. 8, the plurality of regions may be formed in hologram element 40 to cause at least one of the diffraction efficiency of hologram element 40 or the optimum incident angle relative to the deflection angle of image light in hologram element 40 to repeat a monotonic increase and a monotonic decrease in hologram element 40.

In the optical member using the conventional hologram element, as shown in (a1) to (a3) in FIGS. 7 and (a1) to (a3) in FIG. 8, the diffraction efficiency and the optimum incident angle relative to the deflection angle are the same at any positions. For this reason, when the incident angle of image light relative to the hologram element differ, the image light cannot be diffracted sufficiently and a portion occurs where the light amount of image light outputted from the conventional hologram element is reduced. This results in luminance unevenness. However, as shown in (b1) to (b4) in FIGS. 7 and (b1) to (a4) in FIG. 8, optical member 30 using hologram element 40 of the present disclosure is capable of inhibiting luminance unevenness caused by the uneven surface of the light-transmissive portion and the uneven thickness of the light-transmissive portion.

Next, as shown in (b1) to (b3) in FIG. 9, the plurality of regions may include a plurality of high regions arranged in a matrix pattern, and a plurality of low regions, which are other than the plurality of high regions, that satisfy at least one of a first condition that the diffraction efficiency in the plurality of low regions is lower than the diffraction efficiency in the plurality of high regions or a second condition that the difference between the incident angle of image light and the optimum incident angle in hologram element 40 is greater in the plurality of low regions than in the plurality of high regions.

The shape of the plurality of high regions is not limited to a pyramidal polygonal shape as shown in FIG. 9. The shape of the plurality of high regions may be, for example, a truncated cone shape, a cuboid shape, a polygonal shape, a cylindrical shape, etc. For this reason, the shape of the plurality of low regions is not also limited to a specific shape.

In the optical member using the conventional hologram element, as shown in (a1) to (a3) in FIG. 9, the diffraction efficiency and the optimum incident angle relative to the deflection angle are the same at any positions. For this reason, when the incident angle of image light relative to the hologram element differs, the image light cannot be diffracted sufficiently and a portion occurs where the light amount of image light outputted from the conventional hologram element is reduced. This results in luminance unevenness. However, as shown in (b1) to (b3) in FIG. 9, optical member 30 using hologram element 40 of the present disclosure is capable of inhibiting luminance unevenness caused by the uneven surface of the light-transmissive portion and the uneven thickness of the light-transmissive portion.

Next, even when luminance unevenness occurs due to a combination of the luminance unevenness caused by the uneven distribution of image light outputted by image light outputter 50 as shown (a3) in FIG. 10 and the luminance unevenness caused in the case of using light guide 131 having an uneven thickness as shown in (a2) in FIG. 10, optical member 30 using hologram element 40 of the present disclosure is capable of inhibiting the luminance unevenness caused by the uneven distribution of image light outputted by image light outputter 50 and the uneven thickness of light guide 131, by adjusting at least one of the diffraction efficiency or the deflection angle of image light.

### VARIATION

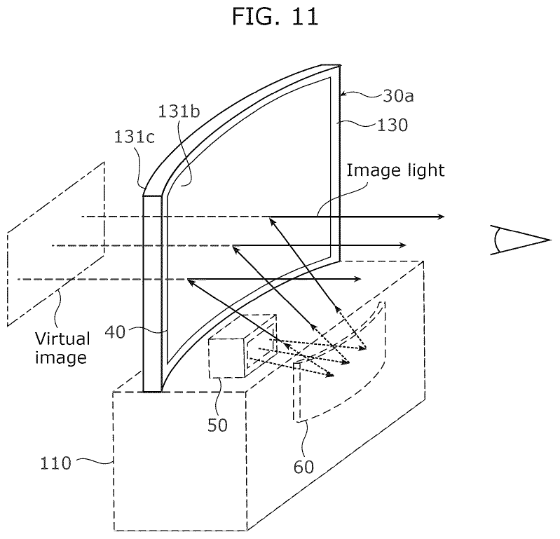

With reference to FIG. 11, the following describes optical member 30a of the present variation.

FIG. 11 is a diagram showing display device 1b that uses combiner 130. FIG. 11 shows an example case where an example of the light-transmissive portion is combiner 130.

The present variation is different from the foregoing embodiment in that combiner 130 is used instead of the light guide described above. In the present variation, the same elements as those in the foregoing embodiment are assigned the same reference marks and the description thereof is omitted as appropriate.

Display device 1b of the present variation includes device body 110, image light outputter 50 and reflector 60 disposed in device body 110, and optical member 30. Optical member 30a includes combiner 130 and hologram elements 40.

Device body 110 is disposed in and fixed to the dashboard of vehicle 2.

Image light outputter 50 outputs image light toward reflector 60.

Reflector 60 is a reflection mirror that reflects, toward combiner 130, the image light outputted by image light outputter 50. Stated differently, the image light outputted by image light outputter 50 enters and is reflected by reflector 60 to enter combiner 130.

Combiner 130 is configured in the form of a half-mirror, using, for example, a transmissive resin material. Hologram elements 40 are provided in combiner 130. Hologram elements 40 may be provided on output surface 131b of combiner 130, or on surface 131c on the opposite side, or may be internally included in combiner 130.

Output surface 131b of combiner 130, which is the surface facing the user, displays an image. By the image light reflected by reflector 60 being projected, it is possible for output surface 131b to display a virtual image. Stated differently, combiner 130 is capable of displaying a virtual image corresponding to the image by means of the image light reflected and diffracted by hologram elements 40. Also, surface 131c on the opposite side of output surface 131b of combiner 130 is the surface which faces front window 3 in FIG. 1, and from which light including the scenery enters from a forward direction via front window 3. For this reason, combiner 130 is provided for the user to visually recognize the traveling direction of vehicle 2 through combiner 130. Stated differently, the user is able to see the image of combiner 130 overlaid on the forward scenery that is seen through front window 3 in the traveling direction of vehicle 2 in FIG. 1.

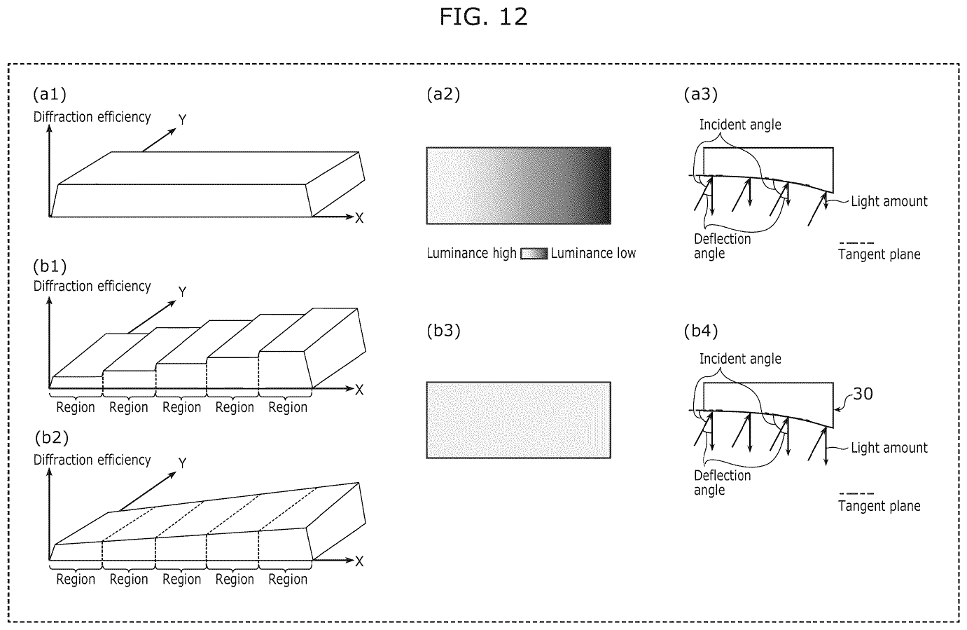

Combiner 130 is a plate having a convex shape or a concave shape. Output surface 131b of combiner 130 is, for example, a curved surface. Combiner 130 has an approximately rectangular shape in a plan view, but is not limited to having a specific shape, and thus may have, for example, a polygonal shape, a circular shape, etc. Next, with reference to FIG. 12 to FIG. 16, a specific configuration of hologram elements 40 is described.

FIG. 12 is a diagram showing the diffraction efficiency of the conventional hologram element that uses a combiner, the deflection angle and the incident angle of image light in the conventional hologram element, the diffraction efficiency of hologram element 40 in the case where the diffraction efficiency monotonically increases from one side to the other side of hologram element 40, and the deflection angle and the incident angle of image light in hologram element 40. Note that FIG. 12 omits the illustration of hologram element 40. This is applicable to the subsequent drawings.

In FIG. 12, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element. In FIG. 12, (b1) shows the diffraction efficiency of hologram element 40 that nonlinearly increases, (b2) shows the diffraction efficiency of hologram element 40 that linearly increases, (b3) shows the luminance that has been made even by optical member 30 in the case of using hologram element 40, and (b4) shows the deflection angle and the incident angle of image light that monotonically increase in curved hologram element 40, and the light amount of light outputted from curved hologram element 40. Each light amount is indicated by the length of an arrow.

The description for FIG. 12 is the same as that for FIG. 5 described above, and thus omitted.

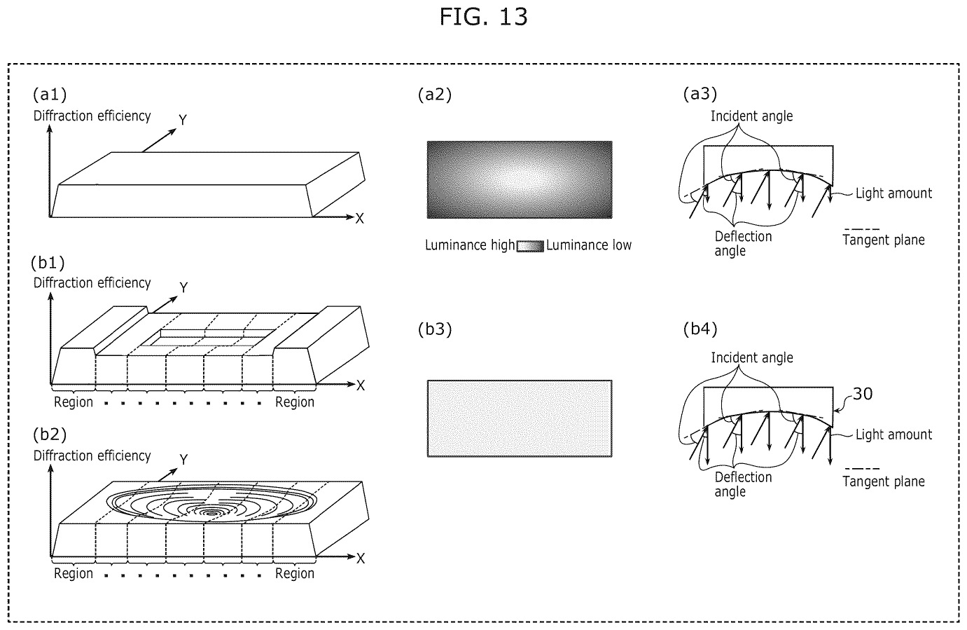

FIG. 13 is a diagram showing the diffraction efficiency of the conventional hologram element that uses the combiner, the deflection angle and the incident angle of image light in the conventional hologram element, the diffraction efficiency of hologram element 40 in the case where the diffraction efficiency monotonically increases from the central portion to edges of hologram element 40, and the deflection angle and the incident angle of image light in hologram element 40.

In FIG. 13, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element.

In FIG. 13, (b1) shows the diffraction efficiency of hologram element 40 that nonlinearly increases, (b2) shows the diffraction efficiency of hologram element 40 that monotonically increases, (b3) shows the luminance that has been made even by optical member 30 in the case of using hologram element 40, and (b4) shows the deflection angle and the incident angle of image light that monotonically increase in curved hologram element 40, and the light amount of light outputted from curved hologram element 40.

The description for FIG. 13 is the same as that for FIG. 6 described above, and thus omitted.

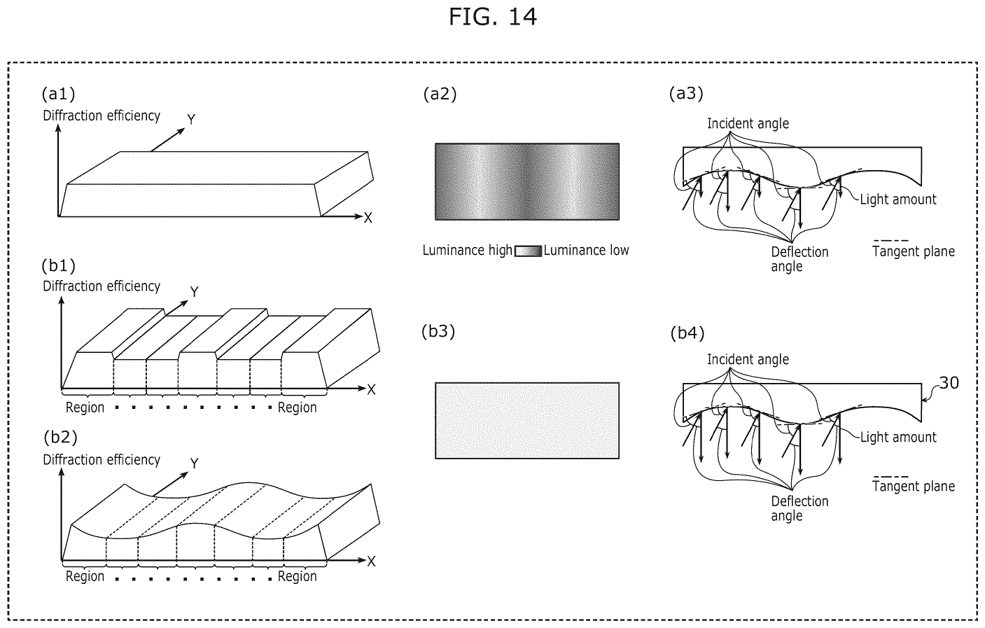

FIG. 14 is a diagram showing the diffraction efficiency of the conventional hologram element that uses the combiner, the deflection angle and the incident angle of image light in the conventional hologram element, the diffraction efficiency of hologram element 40 in the case where the diffraction efficiency repeats a monotonic increase and a monotonic decrease in hologram element 40, and the deflection angle and the incident angle of image light in hologram element 40.

In FIG. 14, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element. In FIG. 14, (b1) shows the diffraction efficiency of hologram element 40 that repeats a monotonic increase and a monotonic decrease in the X-axis direction, (b2) shows another diffraction efficiency of hologram element 40 that repeats a monotonic increase and a monotonic decrease in the X-axis direction, (b3) shows the luminance that has been made even by optical member 30 in the case of using hologram element 40, and (b4) shows the deflection angle and the incident angle of image light that repeat a monotonic increase and a monotonic decrease in waved hologram element 40, and the light amount of light outputted from waved hologram element 40.

The description for FIG. 14 is the same as that for FIG. 7 described above, and thus omitted.

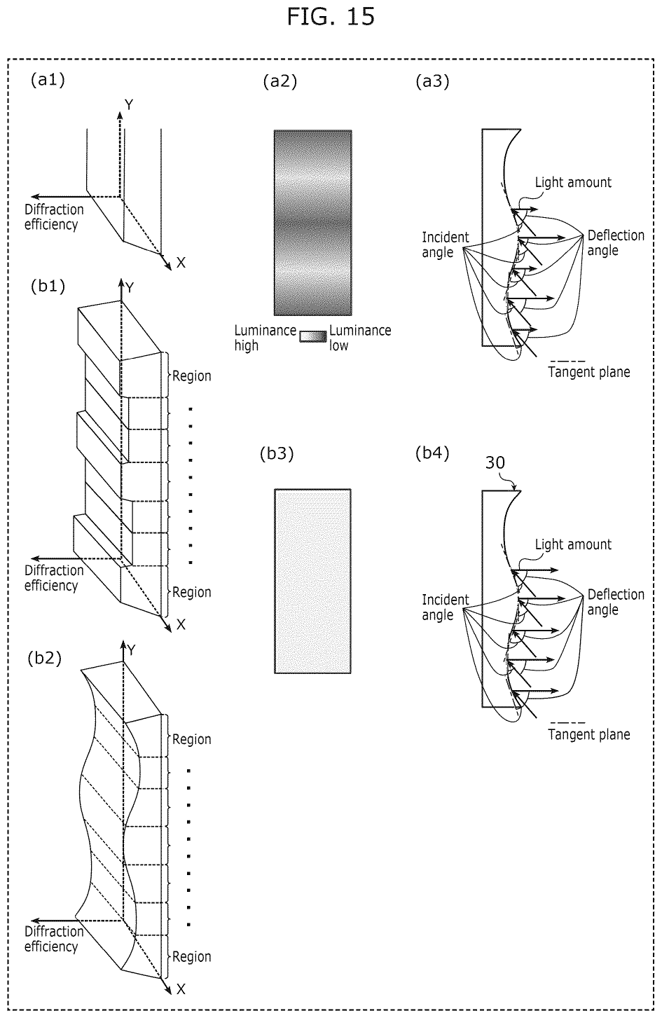

FIG. 15 is another diagram showing the diffraction efficiency of the conventional hologram element that uses the combiner, the deflection angle and the incident angle of image light in the conventional hologram element, the diffraction efficiency of hologram element 40 in the case where the diffraction efficiency repeats a monotonic increase and a monotonic decrease in hologram element 40, and the deflection angle and the incident angle of image light in hologram element 40.

In FIG. 15, (a1) shows the diffraction efficiency of the conventional hologram element in which the regions of the present disclosure are not formed, (a2) shows the luminance unevenness in the optical member in the case of using the conventional hologram element, and (a3) shows the deflection angle and the incident angle of image light in the conventional hologram element, and the light amount of light outputted from the conventional hologram element. In FIG. 15, (b1) shows the diffraction efficiency of hologram element 40 that repeats a monotonic increase and a monotonic decrease in the Y-axis direction, (b2) shows another diffraction efficiency of hologram element 40 that repeats a monotonic increase and a monotonic decrease in the Y-axis direction, (b3) shows the luminance that has been made even by optical member 30 in the case of using hologram element 40, and (b4) shows the deflection angle and the incident angle of image light that repeat a monotonic increase and a monotonic decrease in waved hologram element 40, and the light amount of light outputted from waved hologram element 40.

The description for FIG. 15 is the same as that for FIG. 8 described above, and thus omitted.

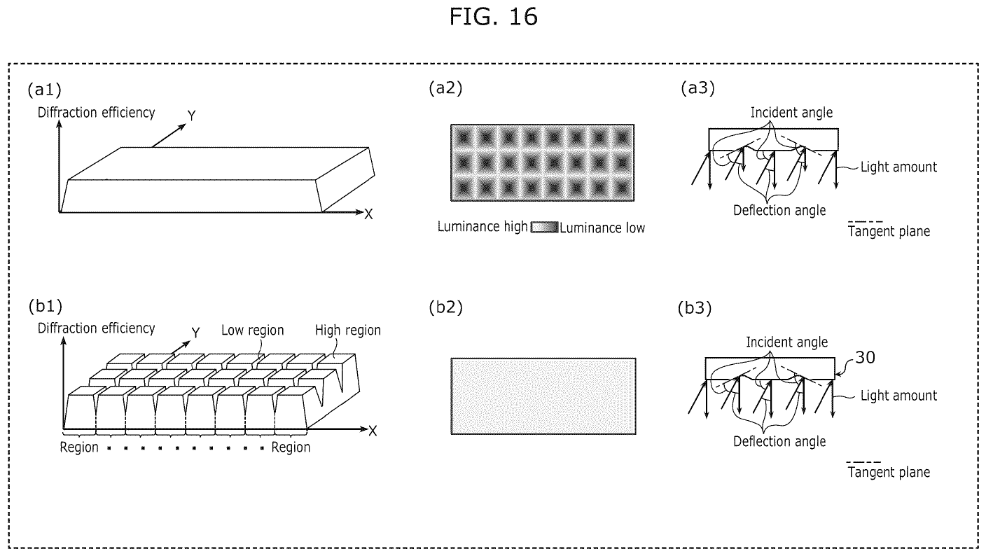

FIG. 16 is a diagram showing the diffraction efficiency of the conventional hologram element that uses the combiner, the deflection angle and the incident angle of image light in the conventional hologram element, the diffraction efficiency of hologram element 40 in the case of using hologram element 40 that includes a plurality of high and low regions, and the deflection angle and the incident angle of image light in hologram element 40.

In FIG. 16, (a1) shows the diffraction efficiency of the conventional hologram element in which the regions of the present disclosure are not formed, (a2) shows luminance unevenness in the optical member in the case of using the conventional hologram element, and (a3) shows the deflection angle and the incident angle of image light in the conventional hologram element, and the light amount of light outputted from the conventional hologram element.

In FIG. 16, (b1) shows the diffraction efficiency of hologram element 40 in which a plurality of high and low regions arranged in a matrix pattern are formed, (b2) shows the luminance that has been made even by optical member 30 in the case of using hologram element 40 in which the plurality of high and low regions arranged in a matrix pattern are formed, and (b3) shows the deflection angle and the incident angle of image light in hologram element 40 in which the plurality of high and low regions arranged in a matrix pattern are formed, and the light amount of light outputted from hologram element 40 in which the plurality of high and low regions arranged in a matrix pattern are formed.

The description for FIG. 16 is the same as that for FIG. 9 described above, and thus omitted.

### <Manufacturing Method>

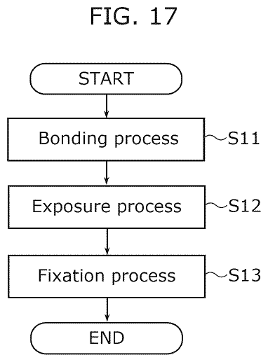

With reference to FIG. 17, the following describes a manufacturing method of manufacturing optical member 30, 30a. FIG. 17 is a flowchart showing a manufacturing method of manufacturing optical member 30, 30a.

The manufacturing method of manufacturing optical member 30, 30a is a method of manufacturing optical member 30, 30a including: hologram elements 40 that diffract image light representing an image generated by image light outputter 50 and outputs the diffracted image light; and a light-transmissive portion in which hologram elements 40 are provided.

First, as the bonding process, a photosensitive material to serve as hologram elements 40 is bonded onto a surface of the base material serving as the base of the light-transmissive portion (S11). Next, in the exposure process, the photosensitive material is subjected to laser light radiation, using a laser device, thereby subjecting the photosensitive material to dual-beam interference exposure using laser light (S12). Diffraction efficiency is set by adjusting the intensity (output) of the laser light. A deflection angle is set by adjusting the incident angle of the laser light. For example, as shown in (b4) in FIG. 5, the optimum incident angle relative to the deflection angle is set by changing the angle at which the laser light enters hologram element 40, with the deflection angle kept constant. In the photosensitive material, at least one of the diffraction efficiency, the deflection angle, or the optimum incident angle relative to the deflection angle is set for each of the plurality of regions that include the first region and the second region different from the first region. With this, hologram elements 40 in which a plurality of desired regions are provided are formed.

Next, as the fixation process, the photosensitive material is subjected to ultraviolet light radiation, thereby fixing the photosensitive material to the base material (S13).

Through the foregoing processes, the light-transmissive portion is obtained in which hologram elements 40 are provided.

### Working Effects

The following describes the working effects achieved by optical member 30, 30a, display device 1, 1a, 1b, and the manufacturing method in the present embodiment.

The optical device of PTL 1 can be improved upon in that light seen through the hologram optical element cannot be evenly viewed in the case where, for example, the surface of the transparent base member is uneven, the thickness of the transparent base member is uneven, the distribution of light outputted by a video display element is uneven, dual-beam light used for exposure is uneven despite that the diffraction efficiency is set at a constant value, and unevenness occurs due to the characteristics of the material used for the hologram optical element.

As described above, optical member 30, 30a of technology 1 in the present embodiment includes: hologram element 40 that diffracts image light representing an image generated by image light outputter 50 and outputs the image light diffracted; and a light-transmissive portion (light guide 31, combiner 130) in which hologram element 40 is provided. Hologram element 40 includes a plurality of regions including a first region and a second region different from the first region. To inhibit luminance unevenness caused by an uneven surface of the light-transmissive portion, an uneven thickness of the light-transmissive portion, or an uneven distribution of the image light outputted by image light outputter 50, the first region and the second region are different in at least one of diffraction efficiency of hologram element 40, a deflection angle of the image light in hologram element 40, or an optimum incident angle relative to the deflection angle.

With this, even when the surface of the light-transmissive portion is uneven, the thickness of the light-transmissive portion is uneven, or the distribution of the image light is uneven, the first region and the second region capable of coping with the unevenness caused by these are provided in hologram element 40 to inhibit the unevenness. It is thus possible to inhibit luminance unevenness of the image light outputted from display device 1, 1a, 1b.

Thus, according to optical member 30, 30a, it is possible to output image light having an even distribution.

Also, optical member 30, 30a of technology 2 in the present embodiment is optical member 30, 30a according to technology 1. In this case, the plurality of regions are provided in hologram element 40 to cause the at least one of the diffraction efficiency of hologram element 40, the deflection angle of the image light in hologram element 40, or the optimum incident angle relative to the deflection angle to monotonically change from one side to an other side of hologram element 40.

With this, in the luminance unevenness caused by unevenness, when the luminance monotonically increases from one side to the other side of optical member 30, 30a, for example, it is possible to inhibit the luminance unevenness of the image light outputted from display device 1, 1a, 1b, using hologram element 40 in which a plurality of regions are provided to cause the luminance to monotonically increase from one side to the other side.

Also, optical member 30, 30a of technology 3 in the present embodiment is optical member 30, 30a according to technology 2. In this case, the plurality of regions are provided in hologram element 40 to cause the at least one of the diffraction efficiency of hologram element 40, the deflection angle of the image light in hologram element 40, or the optimum incident angle relative to the deflection angle to linearly change from the one side to the other side of hologram element 40.

With this, in the luminance unevenness caused by unevenness, when the luminance linearly increases from one side to the other side of optical member 30, 30a, for example, it is possible to inhibit the luminance unevenness of the image light outputted from display device 1, 1a, 1b, using hologram element 40 in which a plurality of regions are provided to cause the luminance to linearly increase from one side to the other side.

Also, optical member 30, 30a of technology 4 in the present embodiment is optical member 30, 30a according to technology 2. In this case, the plurality of regions are provided in hologram element 40 to cause the at least one of the diffraction efficiency of hologram element 40, the deflection angle of the image light in hologram element 40, or the optimum incident angle relative to the deflection angle to nonlinearly change from the one side to the other side of hologram element 40.

With this, in the luminance unevenness caused by unevenness, when the luminance nonlinearly increases from one side to the other side of optical member 30, 30a, for example, it is possible to inhibit the luminance unevenness of the image light outputted from display device 1, 1a, 1b, using hologram element 40 in which a plurality of regions are provided to cause the luminance to nonlinearly increase from one side to the other side.

Also, optical member 30, 30a of technology 5 in the present embodiment is optical member 30, 30a according to technology 1.

In this case, the plurality of regions are provided in hologram element 40 to cause the at least one of the diffraction efficiency of hologram element 40, the deflection angle of the image light in hologram element 40, or the optimum incident angle relative to the deflection angle to monotonically change from a central portion to an edge of hologram element 40.

With this, in the luminance unevenness caused by unevenness, when the luminance monotonically increases from an edge to the central portion in optical member 30, 30a, for example, it is possible to inhibit the luminance unevenness of the image light outputted from display device 1, 1a, 1b, using hologram element 40 in which a plurality of regions are provided to cause the luminance to monotonically increase from the central portion to the edge.

Also, optical member 30, 30a of technology 6 in the present embodiment is optical member 30, 30a according to technology 5. In this case, the plurality of regions are provided in hologram element 40 to cause the at least one of the diffraction efficiency of hologram element 40, the deflection angle of the image light in hologram element 40, or the optimum incident angle relative to the deflection angle to linearly change from the central portion to the edge of hologram element 40.

With this, in the luminance unevenness caused by unevenness, when the luminance linearly increases from an edge to the central portion of optical member 30, 30a, for example, it is possible to inhibit the luminance unevenness of the image light outputted from display device 1, 1a, 1b, using hologram element 40 in which a plurality of regions are provided to cause the luminance to linearly increase from the central portion to the edge of optical member 30 30a.

Also, optical member 30, 30a of technology 7 in the present embodiment is optical member 30, 30a according to technology 5. In this case, the plurality of regions are provided in hologram element 40 to cause the at least one of the diffraction efficiency of hologram element 40, the deflection angle of the image light in hologram element 40, or the optimum incident angle relative to the deflection angle to nonlinearly change from the central portion to the edge of hologram element 40.

With this, in the luminance unevenness caused by unevenness, when the luminance nonlinearly increases from an edge to the central portion of optical member 30, 30a, for example, it is possible to inhibit the luminance unevenness of the image light outputted from display device 1, 1a, 1b, using hologram element 40 in which a plurality of regions are provided to cause the luminance to nonlinearly increase from the central portion to the edge of optical member 30, 30a.

Also, optical member 30, 30a of technology 8 in the present embodiment is optical member 30, 30a according to any one of technologies 1, 2, 4, 5, and 7. In this case, in each of the plurality of regions, at least one of the diffraction efficiency of hologram element 40, the deflection angle of the image light in hologram element 40, or the optimum incident angle relative to the deflection angle is constant.

With this, it is possible to set the diffraction efficiency of hologram element 40 and the optimum incident angle relative to the deflection angle of image light in hologram element 40 on a region-by-region basis in accordance with the luminance unevenness of the image light outputted from display device 1, 1a, 1b. The use of such hologram element 40 makes it possible to inhibit the luminance unevenness of the image light outputted from display device 1, 1a, 1b.

Also, optical member 30, 30a of technology 9 in the present embodiment is optical member 30, 30a according to any one of technologies 1 to 7. In this case, in each of the plurality of regions, at least one of the diffraction efficiency of hologram element 40, the deflection angle of the image light in hologram element 40, or the optimum incident angle relative to the deflection angle continuously changes.

With this, it is possible to set the diffraction efficiency of hologram element 40 and the optimum incident angle relative to the deflection angle of image light in hologram element 40 on a region-by-region basis in accordance with the gradient of the luminance unevenness of the image light outputted from display device 1, 1a, 1b. The use of such hologram element 40 makes it possible to inhibit the luminance unevenness of the image light outputted from display device 1, 1a, 1b.

Also, optical member 30, 30a of technology 10 in the present embodiment is optical member 30, 30a according to technology 1. In this case, the plurality of regions are provided in hologram element 40 to cause the at least one of the diffraction efficiency of hologram element 40 or the optimum incident angle relative to the deflection angle of the image light in hologram element 40 to repeat a monotonic increase and a monotonic decrease in hologram element 40.

With this, in the luminance unevenness caused by unevenness, when the luminance changes in a manner that a monotonic increase and a monotonic decrease are repeated from the other side to one side of optical member 30, 30a, for example, it is possible to inhibit the luminance unevenness of the image light outputted from display device 1, 1a, 1b, using hologram element 40 in which a plurality of regions are provided to cause the luminance to repeat a monotonic increase and a monotonic decrease from one side to the other side.

Also, optical member 30, 30a of technology 11 in the present embodiment is optical member 30, 30a according to technology 1. In this case, the plurality of regions include: a plurality of high regions arranged in a matrix pattern; and a low region that satisfies at least one of a first condition or a second condition, the first condition being that the diffraction efficiency in the low region is lower than the diffraction efficiency in the plurality of high regions, the second condition being that a difference between an incident angle and the optimum incident angle of the image light in hologram element 40 is greater in the low region than in the plurality of high regions.

With this, when the luminance unevenness of optical member 30, 30a caused by unevenness is in a matrix pattern, for example, it is possible to inhibit the luminance unevenness of the image light outputted from display device 1, 1a, 1b, using hologram element 40 that includes the plurality of high regions arranged in a matrix pattern and the low region, which is other than the plurality of high regions.

Also, optical member 30, 30a of technology 12 in the present embodiment is optical member 30, 30a according to any one of technologies 1 to 11. In this case, the light-transmissive portion is light guide 31, 131 through which the image light propagates and which internally includes a plurality of hologram elements 40. The plurality of hologram elements 40 include a first hologram element and a second hologram element. The first hologram element is located closer to a light-incident side of light guide 31, 131 than the second hologram element is, the light-incident side being a side from which the image light outputted by image light outputter 50 enters. With this, it is possible to inhibit the luminance unevenness of the image light outputted from display device 1, 1a, 1b that includes the first hologram element and the second hologram element.

Also, optical member 30, 30a of technology 13 in the present embodiment is optical member 30, 30a according to technology 12. In this case, when light guide 31, 131 has an uneven thickness, the plurality of hologram elements 40 are provided to inhibit luminance unevenness caused by the uneven thickness of light guide 31, 131 and to adjust the deflection angle of the image light in the plurality of hologram elements 40.

With this, when the luminance unevenness is present due to the uneven thickness of light guide 31, 131, for example, it is possible to adjust the deflection angle of the image light in hologram element 40 in accordance with the unevenness in the thickness of light guide 31,131. This inhibits the luminance unevenness of the image light outputted from display device 1, 1a, 1b.

Also, optical member 30, 30a of technology 14 in the present embodiment is optical member 30, 30a according to any one of technologies 1 to 13. In this case, when the light-transmissive portion has the uneven surface, hologram element 40 is provided to inhibit the luminance unevenness caused by the uneven surface of the light-transmissive portion and to adjust at least one of the diffraction efficiency of hologram element 40, the deflection angle of the image light in hologram element 40, or the optimum incident angle relative to the deflection angle.

With this, when the luminance unevenness is present due to the surface of the light-transmissive portion, for example, it is possible to inhibit the luminance unevenness of the image light outputted from display device 1, 1a, 1b, using hologram element 40 that has been adjusted as described above.

Also, optical member 30, 30a of technology 15 in the present embodiment is optical member 30, 30a according to any one of technologies 1 to 14. In this case, when the image light outputted by image light outputter 50 has the uneven distribution, hologram element 40 is provided to inhibit the luminance unevenness caused by the uneven distribution of the image light outputted by image light outputter 50 and to adjust at least one of the diffraction efficiency of hologram element 40, the deflection angle of the image light in hologram element 40, or the optimum incident angle relative to the deflection angle.

With this, even when the distribution of the image light outputted by image light outputter 50 is uneven, it is possible to inhibit the luminance unevenness of the image light outputted from display device 1, 1a, 1b, using hologram element 40 that has been adjusted as described above.

Also, optical member 30, 30a of technology 16 in the present embodiment is optical member 30, 30a according to any one of technologies 1 to 15. In this case, the plurality of regions further include a third region. The first region and the second region are different, in a first direction (X-axis direction or Y-axis direction), in at least one of the diffraction efficiency of hologram element 40, the deflection angle of the image light in hologram element 40, or the optimum incident angle relative to the deflection angle. The first region and the third region are different, in a second direction (Y-axis direction or X-axis direction) different from the first direction, in at least one of the diffraction efficiency of hologram element 40, the deflection angle of the image light in hologram element 40, or the optimum incident angle relative to the deflection angle.

With this, it is possible to make at least one of the diffraction efficiency of hologram element 40, the deflection angle of the image light in hologram element 40, or the optimum incident angle relative to the deflection angle different, not only in the first direction but also in the second direction. For this reason, even when the surface of the light-transmissive portion is uneven, the thickness of the light-transmissive portion is uneven, or the distribution of the image light outputted from image light outputter 50 is uneven, it is possible to set the diffraction efficiency, the deflection angle of the image light, and the optimum incident angle relative to the deflection angle to cope with such unevenness. As a result, it is possible to inhibit the luminance unevenness of the image light outputted from display device 1, 1a, 1b.

Also, optical member 30, 30a of technology 17 in the present embodiment is optical member 30, 30a according to any one of technologies 1 to 11 and 14 to 16. In this case, the light-transmissive portion is combiner 130 that internally includes a plurality of hologram elements 40.

With this, it is possible to apply optical member 30, 30a of the present disclosure also to combiner 130.

Also, optical member 30, 30a of technology 18 in the present embodiment is optical member 30, 30a according to any one of technologies 1 to 17. In this case, each of the plurality of regions is a cell at which the image light is diffracted and from which the image light diffracted is outputted.

With this, it is possible to adjust at least one of the diffraction efficiency, the deflection angle of the image light, or the optimum incident angle relative to the deflection angle on a cell-by-cell basis in accordance with the luminance unevenness in optical member 30, 30a caused by unevenness. The use of such hologram element 40 makes it possible to inhibit the luminance unevenness of the image light outputted from display device 1, 1a, 1b.

Also, display device 1, 1a, 1b of technology 19 in the present embodiment includes optical member 30, 30a according to any one of technologies 1 to 18, and image light outputter 50 that outputs the image light to the light-transmissive portion.

Such display device 1, 1a, 1b also achieves the same working effects as those described above.

Also, the manufacturing method of technology 20 in the present embodiment is a manufacturing method of manufacturing optical member 30, 30a including: hologram element 40 that diffracts image light representing an image generated by image light outputter 50 and outputs the image light diffracted; and a light-transmissive portion in which hologram element 40 is provided. Such manufacturing method includes forming, in hologram element 40, a plurality of regions including a first region and a second region different from the first region. To inhibit luminance unevenness caused by an uneven surface of the light-transmissive portion, an uneven thickness of the light-transmissive portion, or an uneven distribution of the image light outputted by image light outputter 50, the first region and the second region are different in at least one of diffraction efficiency of hologram element 40, a deflection angle of the image light in hologram element 40, or an optimum incident angle relative to the deflection angle.

Such manufacturing method also achieves the same working effects as those described above.

The manufacturing method of technology 21 in the present embodiment is the manufacturing method according to technology 20. In this case, in each of the plurality of regions, at least one of the diffraction efficiency of hologram element 40, the deflection angle of the image light in hologram element 40, or the optimum incident angle relative to the deflection angle continuously changes.

With this, it is possible to obtain hologram element 40 in which the diffraction efficiency, the deflection angle of the image light, and the optimum incident angle relative to the deflection angle are adjusted on a region-by-region basis in accordance with the gradient of the luminance unevenness of the image light outputted from display device 1, 1a, 1b.

The manufacturing method of technology 22 in the present embodiment is the manufacturing method according to technology 20 or 21. In this case, each of the plurality of regions is a cell at which the image light is diffracted and from which the image light diffracted is outputted.

With this, it is possible to obtain hologram element 40 in which at least one of the diffraction efficiency, the deflection angle of the image light, or the optimum incident angle relative to the deflection angle is adjusted on a cell-by-cell basis in accordance with the luminance unevenness in optical member 30, 30a caused by unevenness.

### OTHER VARIATIONS

The optical member, the display device, and the manufacturing method according to the present disclosure have been described above on the basis of the embodiment, but the present disclosure is not limited to the foregoing embodiment. The scope of the present disclosure may also include an embodiment achieved by making various modifications to the embodiment that can be conceived by those skilled in the art without departing from the essence of the present disclosure.

In the foregoing embodiment, for example, at least one of the diffraction efficiency of hologram element 40, the deflection angle of image light in hologram element 40, or the optimum incident angle relative to the deflection angle may monotonically change from the central portion to edges of hologram element 40. This case is indicated as (b1), (b2), and (b4) in FIG. 6, and (b1), (b2), and (b4) in FIG. 13.

Also, in the foregoing embodiment, the plurality of regions may include a plurality of low regions arranged in a matrix pattern and a plurality of high regions, which are other than the plurality of low regions, that satisfy at least one of a third condition that the diffraction efficiency in the plurality of high regions is higher than the diffraction efficiency in the plurality of low regions or a fourth condition that the difference between the incident angle of image light and the optimum incident angle in the hologram element is smaller in the plurality of high regions than in the plurality of low regions. This case is indicated as the inversion symmetry of (b1) and (b3) in FIG. 9, and (b1) and (b3) in FIG. 16.

Also, in the foregoing embodiment, for example, at least one of the diffraction efficiency of input hologram element 41, the deflection angle of image light in input hologram element 41, or the optimum incident angle relative to the deflection angle may monotonically change more from the central portion toward an edge portion of input hologram element 41. For example, the diffraction efficiency of input hologram element 41 may monotonically increase more from the central portion toward the edge portion of input hologram element 41. In addition, the difference between the incident angle of image light in input hologram element 41 and the optimum incident angle relative to the deflection angle may monotonically decrease more from the central portion toward the edge portion of input hologram element 41. This is because the luminance distribution of image light outputted from image light outputter 50 tends to decrease more from the central portion toward an edge.

Also, in the foregoing embodiment, at least one of the diffraction efficiency, the deflection angle of image light, or the optimum incident angle relative to the deflection angle in output hologram element 43 may be adjusted more as the distance from folding hologram element 42 increases. Also, at least one of the diffraction efficiency, the deflection angle of image light, or the optimum incident angle relative to the deflection angle in folding hologram element 42 may be adjusted more as the distance from input hologram element 41 increases. For example, the diffraction efficiency of output hologram element 43 may gradually increase more as the distance from folding hologram element 42 increases. Also, the difference between the incident angle of image light in output hologram element 43 and the optimum incident angle relative to the deflection angle may gradually decrease as the distance from folding hologram element 42 increases. Also, the diffraction efficiency of folding hologram element 42 may gradually increase more as the distance from input hologram element 41 increases. Also, the difference between the incident angle of image light in folding hologram element 42 and the optimum incident angle relative to the deflection angle may gradually decrease as the distance from input hologram element 41 increases. This is because the luminance of image light outputted from output hologram element 43 tends to decrease as the distance from folding hologram element 42 in the upstream increases, and the luminance of image light outputted from folding hologram element 42 tends to decrease as the distance from input hologram element 41 in the upstream increases.

In addition, in the foregoing embodiment, when dual-beam light used for exposure is uneven despite that the diffraction efficiency is set at a constant value at the time of exposure, at least one of the diffraction efficiency of hologram element 40, the deflection angle of image light in hologram element 40, or the optimum incident angle relative to the deflection angle may be adjusted, in consideration of the unevenness that occurs due to the characteristics of the material used for hologram element 40, the diffraction efficiency of hologram element 40, to inhibit the luminance unevenness of image light outputted from display device 1, 1a, 1b.

Also, in the foregoing embodiment, an example is shown in which hologram elements 40 are reflective holograms that reflect and diffract light, but hologram elements 40 may also be configured in the form of transmissive holograms that transmit and diffract light.

Note that the present disclosure also includes an embodiment achieved by making various modifications to the foregoing embodiment that can be conceived by those skilled in the art, and an embodiment achieved by freely combining elements and functions in the foregoing embodiment without departing from the essence of the present disclosure.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosure of the following patent application including specification, drawings, and claims are incorporated herein by reference in their entirety: Japanese Patent Application No. 2023-209348 filed on Dec. 12, 2023.

### INDUSTRIAL APPLICABILITY

The present disclosure is applicable for use as, for example, a display device such as a head-up display in a vehicle.

1. An optical member comprising:
a hologram element that diffracts image light representing an image generated by an image light outputter and outputs the image light diffracted; and
a light-transmissive portion in which the hologram element is provided,
wherein the hologram element includes a plurality of regions including a first region and a second region different from the first region, and
to inhibit luminance unevenness caused by an uneven surface of the light-transmissive portion, an uneven thickness of the light-transmissive portion, or an uneven distribution of the image light outputted by the image light outputter, the first region and the second region are different in at least one of diffraction efficiency of the hologram element, a deflection angle of the image light in the hologram element, or an optimum incident angle relative to the deflection angle.

2. The optical member according to claim 1,
wherein the plurality of regions are provided in the hologram element to cause the at least one of the diffraction efficiency, the deflection angle, or the optimum incident angle to monotonically change from one side to an other side of the hologram element.

3. The optical member according to claim 2,
wherein the plurality of regions are provided in the hologram element to cause the at least one of the diffraction efficiency, the deflection angle, or the optimum incident angle to linearly change from the one side to the other side of the hologram element.

4. The optical member according to claim 2,
wherein the plurality of regions are provided in the hologram element to cause the at least one of the diffraction efficiency, the deflection angle, or the optimum incident angle to nonlinearly change from the one side to the other side of the hologram element.

5. The optical member according to claim 1,
wherein the plurality of regions are provided in the hologram element to cause the at least one of the diffraction efficiency, the deflection angle, or the optimum incident angle to monotonically change from a central portion to an edge of the hologram element.

6. The optical member according to claim 5,
wherein the plurality of regions are provided in the hologram element to cause the at least one of the diffraction efficiency, the deflection angle, or the optimum incident angle to linearly change from the central portion to the edge of the hologram element.

7. The optical member according to claim 5,
wherein the plurality of regions are provided in the hologram element to cause the at least one of the diffraction efficiency, the deflection angle, or the optimum incident angle to nonlinearly change from the central portion to the edge of the hologram element.

8. The optical member according to claim 1,
wherein in each of the plurality of regions, at least one of the diffraction efficiency, the deflection angle, or the optimum incident angle is constant.

9. The optical member according to claim 1,
wherein in each of the plurality of regions, at least one of the diffraction efficiency, the deflection angle, or the optimum incident angle continuously changes.

10. The optical member according to claim 1,
wherein the plurality of regions are provided in the hologram element to cause the at least one of the diffraction efficiency or the optimum incident angle to repeat a monotonic increase and a monotonic decrease in the hologram element.

11. The optical member according to claim 1,
wherein the plurality of regions include:
a plurality of high regions arranged in a matrix pattern; and
a low region that is other than the plurality of high regions, and satisfies at least one of a first condition or a second condition, the first condition being that the diffraction efficiency in the low region is lower than the diffraction efficiency in the plurality of high regions, the second condition being that a difference between an incident angle and the optimum incident angle of the image light in the hologram element is greater in the low region than in the plurality of high regions.

12. The optical member according to claim 1,
wherein the light-transmissive portion is a light guide through which the image light propagates and which internally includes a plurality of hologram elements each being the hologram element,
the plurality of hologram elements include a first hologram element and a second hologram element, and
the first hologram element is located closer to a light-incident side of the light guide than the second hologram element is, the light-incident side being a side from which the image light outputted by the image light outputter enters.

13. The optical member according to claim 12,
wherein when the light guide has an uneven thickness, the plurality of hologram elements are provided to inhibit luminance unevenness caused by the uneven thickness of the light guide and to adjust the deflection angle of the image light in the plurality of hologram elements.

14. The optical member according to claim 1,
wherein when the light-transmissive portion has the uneven surface, the hologram element is provided to inhibit the luminance unevenness caused by the uneven surface of the light-transmissive portion and to adjust at least one of the diffraction efficiency, the deflection angle, or the optimum incident angle.

15. The optical member according to claim 1,
wherein when the image light outputted by the image light outputter has the uneven distribution, the hologram element is provided to inhibit the luminance unevenness caused by the uneven distribution of the image light outputted by the image light outputter and to adjust at least one of the diffraction efficiency, the deflection angle, or the optimum incident angle.

16. The optical member according to claim 1,
wherein the plurality of regions further include a third region,
the first region and the second region are different, in a first direction, in at least one of the diffraction efficiency, the deflection angle, or the optimum incident angle, and
the first region and the third region are different, in a second direction different from the first direction, in at least one of the diffraction efficiency, the deflection angle, or the optimum incident angle.

17. The optical member according to claim 1,
wherein the light-transmissive portion is a combiner that internally includes a plurality of hologram elements each being the hologram element.

18. The optical member according to claim 1,
wherein each of the plurality of regions is a cell at which the image light is diffracted and from which the image light diffracted is outputted.

19. A display device comprising:
the optical member according to claim 1; and
the image light outputter that outputs the image light to the light-transmissive portion.

20. A manufacturing method of manufacturing an optical member including: a hologram element that diffracts image light representing an image generated by an image light outputter and outputs the image light diffracted; and a light-transmissive portion in which the hologram element is provided, the manufacturing method comprising:
forming, in the hologram element, a plurality of regions including a first region and a second region different from the first region,
wherein to inhibit luminance unevenness caused by an uneven surface of the light-transmissive portion, an uneven thickness of the light-transmissive portion, or an uneven distribution of the image light outputted by the image light outputter, the first region and the second region are different in at least one of diffraction efficiency of the hologram element, a deflection angle of the image light in the hologram element, or an optimum incident angle relative to the deflection angle.

21. The manufacturing method according to claim 20,
wherein in each of the plurality of regions, at least one of the diffraction efficiency, the deflection angle, or the optimum incident angle continuously changes.

22. The manufacturing method according to claim 20,
wherein each of the plurality of regions is a cell at which the image light is diffracted and from which the image light diffracted is outputted.
